(19) United States
(12) Patent Application Publication
(10) Pub. No.: US 2006/0242058 A1
(43) Pub. Date: Oct. 26, 2006

(54) Transaction system

(76) Inventor: Anthony Torto, Queensland (AU)

Correspondence Address: EDWARDS & ANGELL, LLP, P.O. BOX 55874, BOSTON, MA, 02205, US

(21) Appl. No.: 10/547,600

(22) PCT Filed: Mar. 4, 2004
(86) PCT No.: PCT/AU04/00274

§ 371 Date: May 11, 2006

(30) Foreign Application Priority Data
Mar. 7, 2003 (AU) 2003901043

(51) Int. Cl. G06Q 40/00

(52) U.S. Cl. 705/39; 705/44

(57) ABSTRACT

The present invention provides a method of performing secure transactions between a first party and a second party. The method includes having the first party provide payment details to the second party. The second party then responds by generating a payment request including an indication of the first party and an indication of the transaction. This is provided to a third party which administers an account on behalf of the first party. The third party responds to the payment request to obtain payment from the first party from the account.

### BACKGROUND OF THE INVENTION

The present invention relates to a method and apparatus for a method of performing secure transactions between a user and a merchant, and in particular, between a user end station and a merchant station.

### DESCRIPTION OF THE PRIOR ART

The reference to any prior art in this specification is not, and should not be taken as, an acknowledgement or any form of suggestion that the prior art forms part of the common general knowledge.

Currently, when online users wish to make a payment or purchase via the Internet this is usually performed by having the user visit a merchant web page. The merchant web page will allow the users to select products such as goods or services for purchase. Once the products have been selected the user will typically be presented with a payment page generated by the merchant which often offers a secure technique for making payment.

This may be achieved in one of two main ways. Often, the user is redirected to the merchants financial institution to make the payment. This will be for example an online merchant bank account held with the merchant's bank or other financial institution. In this case, the bank will usually provide to the merchant's software that is downloaded to the merchant's web page and interfaced to allow for real time or batch base credit and charge card authorisations online. This offers the user a greater sense of confidence in transacting online even though the merchant's bank might not be the same as their bank

The bank software will allow the online card user to enter the secure site of the bank of the merchant to provide card details and seek payment authorisation. Card details are transmitted safely online using industry standards secure socket layer encryption.

In this instance the software operated by the merchant's web server will cause the credit card details to be transmitted securely to the bank via this payment page with the details being stored by the bank behind a security firewall. Card details are therefore never disclosed to the merchant. Transactions are completed in real time or are batch based. The payment is then usually received by the merchant the same day or at the latest the next day depending on the time of the transaction.

An alternative process to the one outlined above is for the merchant to have an agreement with an independent broker or agent in relation to the processing of card transactions.

In general these brokers or agents are not as tightly regulated as banks and accordingly, the requirements placed on the merchant are also of a lesser standard level. In these instances the broker or agent will usually allow for a secure payment page and a secure link between the merchant and the online card user. The card user will provide details using this method with the merchant storing these details until it can be transferred to the broker's or agent's system for them to process. Whilst the merchant will store card details in a secure cell behind a firewall pending submission to the broker or agent, this does nevertheless represent a security risk it is therefore desirous to maintain a more secure payment technique.

Similar problems also occur in face-to-face transactions, and telephone transactions.

For example, in the case of telephone transactions, it is necessary for individuals to submit credit card details, or the like, to the merchant providing the respective goods or services. The merchant will then use these details to obtain payment via the user's credit card account. In the case of face-to-face transactions, the user usually provides their credit card to the merchant, allowing the merchant to swipe the credit card to obtain the details.

Thus, in both cases there is the opportunity for scrupulous merchants their employees, and/or third parties to obtain the user's credit card details and apply these fraudulently.

The necessity for improvement of security in card or account based or similar transactions is therefore undisputed. In particular, the incidence of fraud and the consequential losses are substantial, with losses often running in to the billions. Banks/financial institutions, card companies and merchants cumulatively invest millions of dollars annually in an effort to develop systems and practices to curb these losses. Notwithstanding these efforts, fraud remains and grows at an alarming rate, in particular, as more and more people go online to transact.

The common factors present in card fraud or the like are:

1) A third party has obtained sensitive card/account details belonging to another, and

2) Without authorisation, they have used this information to obtain value or financial gain.

### SUMMARY OF THE PRESENT INVENTION

The present invention therefore seeks to ameliorate the problems outlined above by providing an alternative method of transacting, which is capable of integrating with existing systems, and yet has the ability to drastically improve the security of online, and other transactions.

In one example, this is achieved by negating the necessity of the disclosure of sensitive credit card, account details or the like, to any third party and yet allows the transaction and payments to occur. Preferably this is achieved by ensuring that the only details of a transaction that are made known to a third party within the transaction, are a payment indication such as a voucher or the like, which is preferably issued by the paying bank. This sufficiently identifies the transaction, and is used by the merchant to gain payment.

As the payment indication is unique to the particular transaction and the parties thereto, it cannot be used by, or benefit any third party to the transaction. It has a one time use, and thereafter expires or ceases to have any effect or value. This prevents third parties from obtaining sensitive information such as card, account details or the like.

In a first broad form the present invention provides a method of performing secure transactions between a user end station and a merchant station, the method including:
a) Transferring payment details from the end station to the merchant station;
b) Causing the merchant station to:
   i) Generate a payment request including:
      (1) An indication of the user's end station;
      (2) An indication of the transaction; and,
   ii) Transfer the payment request to a financial institution station in accordance with the payment details, the financial institution station holding an account of the user and being responsive to the payment request to obtain payment from the user via the user account.

The account may be at least one of:
a) A bank account; and,
b) A credit card account.

The method can include causing the financial institution station to respond to the payment request to:
a) Initiate a secure connection with the user's end station
b) Obtain security information from the user end station;
c) Process the transaction; and,
d) Provide a payment indication to the merchant station.

The security information can include at least one of:
a) A username;
b) A password;
c) Credit card details;
d) Financial institution account details;
e) An indication of a preferred payment method; and,
f) Any other required information.

The secure connection can be an SSL (single socket layer) connection.

The payment indication can include a voucher, the voucher being used by the merchant to obtain payment.

The method may include:
a) Assigning a unique merchant ID to each merchant;
b) Causing the merchant station to include a unique merchant ID in the payment details; and,
c) Causing the financial institution station to:
   i) Generate a unique identifier in accordance with the merchant ID, and,
   ii) Provide the unique identifier on the voucher.

The merchant station may be adapted to transfer the payment request to the financial institution station via a secure SSL connection.

The method may include:
a) Causing the merchant station to generate web-pages including details of available products;
b) Allowing the user to select one or more of the products;
c) Causing the merchant station to generate a payment amount; and,
d) Causing the user to submit payment details in response to the payment amount.

In a second broad form the present invention provides apparatus for performing secure transactions between a user end station and a merchant station, the apparatus including a merchant end station adapted to:
a) Receive payment details from the end station;
b) Generate a payment request including:
   i) An indication of the user's end station;
   ii) An indication of the transaction; and,
c) Transfer the payment request to a financial institution station in accordance with the payment details, the financial institution station holding an account of the user and being responsive to the payment request to obtain payment from the user via the user account.

The account is generally at least one of:
a) A bank account; and,
b) A credit card account.

The merchant station is generally assigned a respective merchant ID, the merchant station being adapted to include a unique merchant ID in the payment details.

Typically the merchant station is adapted to transfer the payment request to the financial institution station via a secure SSL connection, although other secure connectivity may be used.

The merchant station can be adapted to:
a) Generate web-pages including details of available products;
b) Allow the user to select one or more of the products;
c) Generate a payment amount; and,
d) Receive payment details from the user end station in response to the payment amount.

In general the apparatus is adapted to perform the method of the first broad form of the invention.

In a third broad form the present invention provides apparatus for authorising secure transactions between a user end station and a merchant station, the apparatus including a financial institution station adapted to:
a) Receive a payment request to including:
   i) An indication of the user's end station;
   ii) An indication of the transaction; and,
b) Initiate a secure connection with the user's end station;
c) Obtain security information from the user end station;
d) Process the transaction; and,
e) Provide a payment indication to the merchant station.

The security information typically includes at least one of:
a) A username;
b) A password;
c) Credit card details;
d) Financial institution account details; and,
e) An indication of a preferred payment method.

The secure connection is preferably an SSL connection.

The payment indication can include a voucher, the voucher being used by the merchant to obtain payment.

The payment request can include a unique merchant ID, the financial institution station being adapted to:
a) Generate a unique identifier in accordance with the merchant ID, and,
b) Provide the unique identifier on the voucher.

It will be appreciated that the apparatus of the third broad form of the invention may be used in conjunction with the apparatus of the second broad form of the invention, and/or be used to perform the method of the first broad form of the invention.

In a fourth broad form, the present invention provides a method of performing secure transactions between a user and a merchant, the method including:
a) Having the first party provide payment details to the second party;
b) Causing the second party to:
   i) Generate a payment request including:
      (1) An indication of the first party;
      (2) An indication of the transaction; and,
   ii) Transfer the payment request to a third party in accordance with the payment details, the third party administering an account on behalf of the first party and being responsive to the payment request to obtain payment from the first party from the account.

The third party is typically a financial institution, and preferably administers the account.

The first party is generally a user, with the second party being a merchant.

The account may be at least one of:
a) A bank account; and,
b) A credit card account.

However, it will be appreciated that the account may be any account that allows funds to be allocated on behalf of the user.

The method typically includes causing the third party to respond to the payment request to:
a) Initiate a connection with the user;
b) Obtain security information from the user;
c) Process the transaction; and,
d) Provide a payment indication to the merchant.

The connection is preferably being a secure connection, such as an SSL connection.

The security information typically includes at least one of:
a) A username;
b) A password;
c) Credit card details;
d) Financial institution account details; and,
e) An indication of a preferred payment method.

The payment indication typically includes a voucher, the voucher being used by the merchant to obtain payment, although any alphanumeric code may be used.

The method typically further includes:
a) Assigning a unique ID to each second party;
b) Causing the second party to include the unique ID in the payment details; and,
c) Causing the financial institution to:
   i) Generate a unique identifier in accordance with the unique ID, and,
   ii) Provide the unique identifier on the voucher.

The method can be a method according to the first broad form of the invention.

In a fifth broad form the present invention provides apparatus for performing secure transactions between a first party and a second party, the apparatus including second party end station adapted to:
a) Receive payment details from the first party;
b) Generate a payment request including:
   i) An indication of the first party;
   ii) An indication of the transaction; and,
c) Transfer the payment request to a third party in accordance with the payment details, the third party administering an account on behalf of the first party and being responsive to the payment request to obtain payment from the first party from the account.

In a sixth broad form the present invention provides apparatus for authorising secure transactions between first and second parties, the apparatus including a financial institution station adapted to:
a) Receive a payment request including:
   i) An indication of the first party;
   ii) An indication of the transaction; and,
b) Initiate a secure connection with the first party;
c) Obtain security information from the first party;
d) Process the transaction; and,
e) Provide a payment indication to the second party.

The apparatus of the fifth and sixth broad forms is preferably adapted to perform the method of the fourth broad form of the invention.

In a seventh broad form the present invention provides a system for performing secure transactions between a first party and a second party, the apparatus including a second party end station according to the fifth broad form coupled to a financial institution end station according to the sixth broad form via a communications network.

In an eighth broad form the present invention provides an electronic payment method to enable a user to securely purchase goods and services from a merchant, the method comprising the steps of:
a) accessing a merchant website remotely from a user computer via a computer network;
b) at a merchant website controlled by a merchant computer, enabling the user to select an account held with a financial institution from which payment is to be made;
c) generating a payment request at the merchant computer, said payment request including identification of the user computer, identification of the merchant, the transaction amount and the account;
d) electronically transmitting the payment request from the merchant computer to a financial institution computer, said financial institution computer controlled by the financial institution at which the account is held;
e) at the financial institution computer, initiating a secure communication connection with the user computer;
f) under the control of the user, transmitting security information from the user computer to the financial institution computer; and
g) if the security information is accepted by the financial institution, processing the payment request at the financial institution computer, and thereafter electronically providing a payment indication from the financial institution computer to the merchant computer.

In a ninth broad form the present invention provides an electronic payment method to enable a user to securely pay a merchant from funds in an account, the user operating a user computer and maintaining an account with a financial institution, the method comprising the steps of:
a) accessing a merchant website remotely from the user computer via a computer network;
b) selecting the account held with a financial institution from which payment is to be made;
c) confirming a payment request, said payment request indicating the transaction amount and the account;
d) accepting a secure communication connection request from the financial institution; and
e) electronically transmitting security information from the user computer to the financial institution.

The account is typically a credit card account, or a savings account.

### BRIEF DESCRIPTION OF THE DRAWINGS

An example of the present invention will now be described with reference to the accompanying drawings, in which:—

FIG. 1 is a flow chart of an outline of a process for performing transactions;

FIG. 2 is a schematic diagram of an example of a system for implementing the present invention;

FIG. 3 is a schematic diagram of an example of one of the processing system of FIG. 2;

FIG. 4 is a schematic diagram of an example of one of the end stations of FIG. 2;

FIGS. 5A and 5B are a flow chart of a specific example of the system as implemented via the Internet; and,

FIG. 6 is a preferred example of the process of performing transactions.

### DETAILED DESCRIPTION OF THE PREFERRED EMBODIMENTS

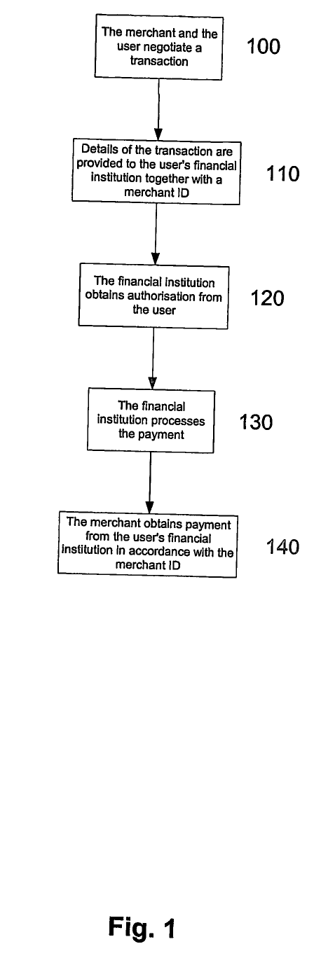

An outline of the process of performing a transaction in accordance with the invention will now be described with reference to FIG. 1.

In particular, at step 100 a merchant and a user (in this case a customer of the merchant) negotiate a transaction. This will typically involve having the user indicate they wish to purchase respective goods or services from the merchant, at an agreed price.

At step 110, details of the transaction are provided to the user's financial institution, together with a merchant ID. In this case, the financial institution is adapted to administer an account on behalf of a user, and may therefore be an entity such as the user's bank, or the like. Alternatively, the financial institution may instead be a third party adapted to communicate with the user's bank on behalf of the user.

The merchant ID is a unique identifier assigned to the merchant in accordance with the invention. The merchant ID is used to identify the merchant to the financial institution. Accordingly, the merchant ID is assigned by a trusted third party.

When the merchant ID is provided to the merchant, it is also sent to any financial institutions that are participating in the transaction scheme. This allows the financial institutions to uniquely identify the merchant and ensure payment is properly provided, as will be described in more detail below.

These transaction details may be provided either by the merchant, or by the user depending on the implementation. If provided by the user, the user may also provide account details specifying an account, or the like, from which payment is to be made.

At step 120, the financial institution operates to obtain authorisation from the user. The authorisation is required to allow the transaction to proceed, thereby preventing fraudulent transactions by third parties. The authorisation is typically achieved by having the user and the financial institution communicate directly, allowing the user to provide security information, or the like. It will be appreciated that this is used to allow the financial institution to confirm the user's identity and to confirm the user's desire for the transaction to proceed. At this point the user may also indicate an account or the like from which the payment is to occur, if this has not already been provided above.

Once the financial institution has authorised the transaction, the financial institution can process the payment at step 130 allowing the merchant to obtain payment from the financial institution, or from another party, such as the user's bank, depending on the implementation at step 140. This is performed in accordance with the merchant ID to ensure that payment is only received by the merchant.

This can be achieved in a number of manners. Thus for example, the financial institution may provide a voucher including the merchant ID, together with other information. This can then be used by the merchant to obtain payment, for example by presenting the voucher to the financial institution in return for the payment. At this point, the merchant will need to provide their merchant ID to identify themselves, and therefore confirm to the financial institution that the merchant is the intended recipient of the payment.

Alternatively, the merchant may define standing instructions for payment when obtaining their merchant ID. In this case, when the merchant ID is initially supplied to the financial institutions, this will be provided together with the standing instructions, which may then be stored in a database. In this case, when the financial institution processes the payment, the financial institution will use the merchant ID received with the transaction details to access the standing instruction, which may include for example details of an account of the merchant. This allows the financial institution to arrange for payment to be made directly into an account of the merchant, thereby ensuring that payment is made to the merchant and not any third party.

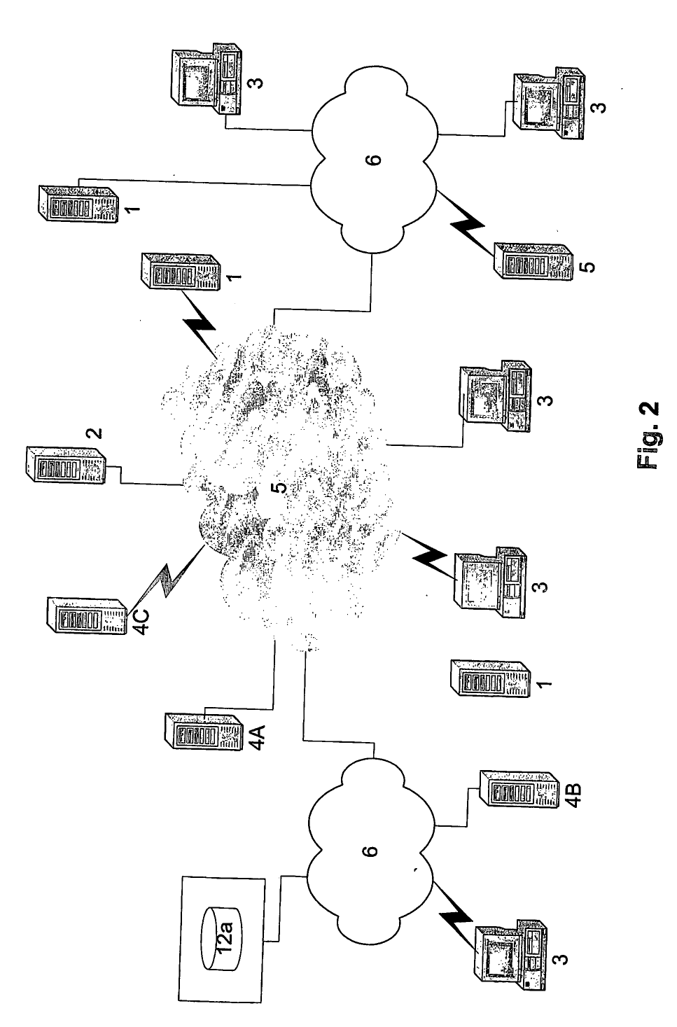

An example of apparatus suitable for implementing the presenting invention will now be described with reference to FIG. 2.

In particular, the apparatus includes a number of merchant servers 1 coupled to a bypass payment server 2, a number of end stations 3, and a number financial institution servers 4 via a communications network such as the Internet 5 and/or one or more LANs (Local Area Networks) 6.

In use, the merchant servers 1 are generally adapted to generate web pages which can be viewed by users of the end station 3. In addition to this, the merchant severs 1 will implement applications software which allows transactions to be performed in accordance with the present invention. This will typically include usual payment schemes such as the use of a shopping basket to allow the user to select products such as goods or services, which are offered for sale on the web site.

The bypass server 2 operates to issue unique bypass IDs to each one of the merchant servers 1 upon registration of the system. The bypass servers 2 will also typically download special applications software to allow the payment method to be implemented, with the software being executed by the merchant servers 1 as mentioned above.

The bypass server 2 will also provide an indication of the merchant IDs to the financial institution servers 4. In use, the financial institution servers 4 operate to process transactions on behalf of users of the system as will be described in more detail below.

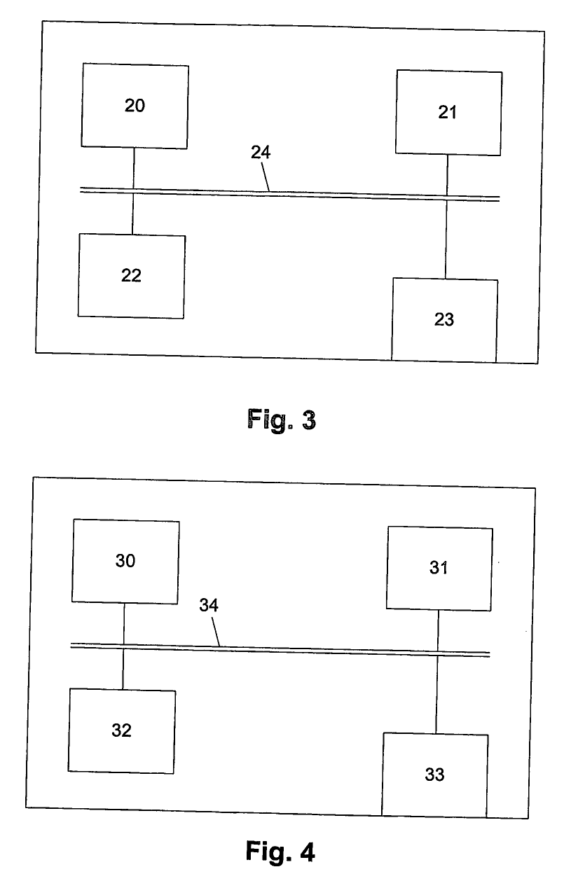

Accordingly, it will be appreciated that the servers 1, 2, 4 may be implemented using any form of processing system. An example of the suitable processing system is shown in FIG. 3.

As shown the processing system includes a processor 20 coupled to a memory 21, an input/output (I/O) device 22 and an external interface 23 via a bus 24. The processor 20 executes application software stored in the memory 21 in order to provide the required functionality. The external interface 23 allows the processing system to be coupled to communications networks and will therefore include modems, network interface cards, or the like.

In use, each of the servers will typically also be coupled to a database (not shown) to allow information to be stored therein. In the case of the merchant servers 1 this may include information regarding the products for sale, the costs of the items, and the merchant ID. In the case of the bypass server 2 this will typically include an indication of the merchants registered with the system together associated merchant IDs. In the case of the financial institution servers 4 this will typically include details of card holders, and may also include merchant IDs.

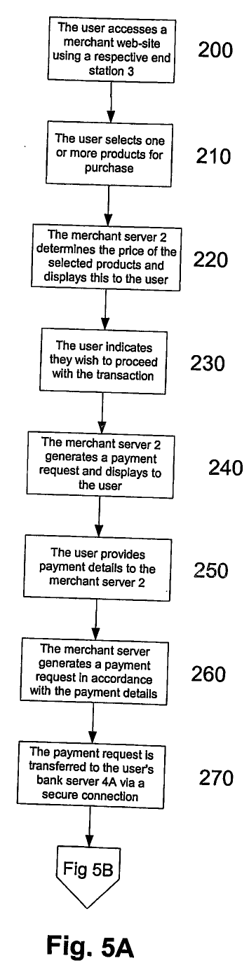

Similarly, the end stations 3 must be capable transferring information to the merchant server 1 and the financial institution server 4, as well as browsing web-pages, or the like. An example of a suitable end station 3 is shown in FIG. 4. In particular, the end station 3 includes a processor 30, a memory 31, an input/output (I/O) device 32, and an external interface 33, coupled together via a bus 34.

Accordingly, it will be appreciated that the end station 3 may be any form of suitable end station, such as a personal computer, PDA, lap-top, mobile phone, or the like. Furthermore, as the transaction may be between two merchants, the end station 3 could be formed from a server, such as a merchant server described above.

### SPECIFIC EXAMPLE

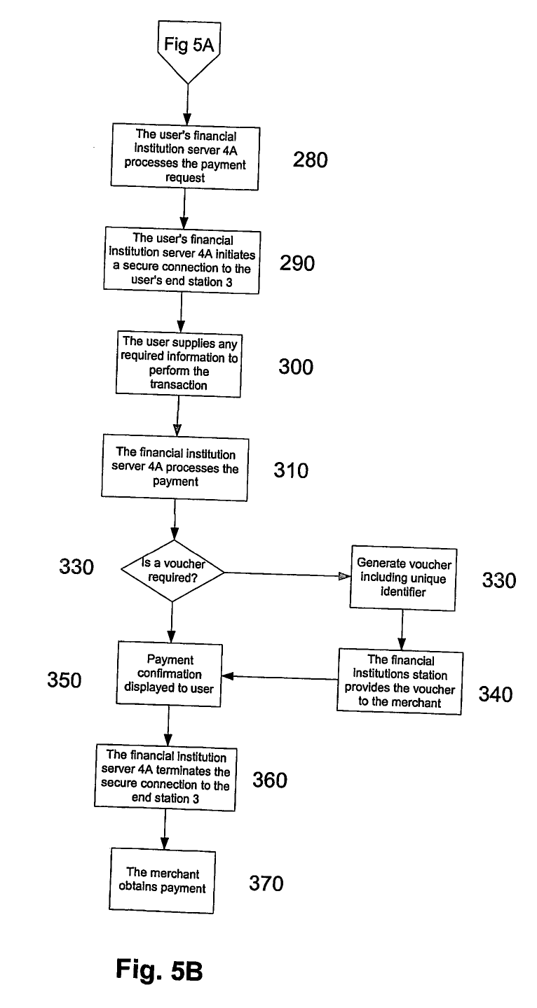

Operation of a specific example of the invention, in which the transaction is to be performed online via the Internet, will now be described with reference to FIGS. 5A and 5B.

In particular, as shown in FIG. 5A at step 200 the user of one of the end stations 3 accesses a merchant web-site via the Internet 2 or the LANs 4.

At step 210 the user selects one or more products for purchase and provides an indication of this to the merchant server. This may be achieved in the normal way for example by selecting products from a list and adding these to a shopping basket or the like.

At step 220 the merchant server 1 determines the price of the selected products and displays this to the user. This may be in the form of a checkout process with the merchant server 1 displaying an indication of the product price on the appropriate web page.

At step 230 the user indicates if they wish to proceed with the transaction typically by simply confirming that this is acceptable.

At step 240 the merchant server 1 generates a payment request and displays this to the user. The payment request will typically include details of for example a billing address and/or delivery address. In addition to this, the user will be required to enter at least details of their own financial institution details in the form of payment details at step 150. The financial institution details must include sufficient information to allow the merchants to identify an appropriate financial institution server 4A, 4B, 4C, 4D which will be adapted to authorise payments on behalf of the user. This will typically be the user's bank, which holds an account of the user, but may be a trusted third party adapted to obtain authorisation from the user's bank on behalf of the user. In this latter case, it will be appreciated that the financial institution details must include sufficient information to allow the financial institution to identify the user's bank.

The user may also provide details of their identity such as name or other personal identification at this stage depending on the method involved. Typically however, this will be provided later, as set out below. It is also possible for steps 220 and 240, and 230 and 250 to be combined, as will be appreciated by those skilled in the art.

At step 260, the merchant server generates a payment request in accordance with the payment details.

This payment request will include the following information:
The unique merchant ID;
The IP address of the user's end station 3;
The transaction amount;
Any payment option selected.

Accordingly, if the user has selected a particular payment option with their payment details this is provided to financial institution. This allows the user to select either for example credit card payment, EFTPOS payment, BPAY payment, or the like, when supplying the details to the merchant. BPAY is a bill payment system developed by a group of Australian banks, and launched in 1997. BPAY is an electronic bill payment service offered by Australian banks, building societies and credit unions as a core feature of internet and phone banking. BPAY allows customers to pay a wide range of bills with via telephone or the Internet. Customer's can pay bills via BPay where the biller and the financial institution have pre-registered. In this case, if any additional information is required by the financial institution this is also provided by the merchant, such as BPAY number or the like.

At step 270 the payment request is transferred to the user's financial institution server 4A via secure connection.

At step 280 the financial institution server 4A processes the payment request before initiating a secure connection to the user's end station 3 at step 290. The user will then be asked to supply any required information to perform the transaction at step 300. This could be performed in a number of manners depending on the respective implementation.

Thus, for example, the user may only require to confirm that the transaction is to proceed if sufficient necessary information was supplied at step 260, or if existing default payment options have been predefined by the user with the financial institution. If the user has only selected an option, such as BPAY or “Pay Anyone” access type payments, the user may be requested to login to their Internet banking account, or provide details of the account to be used. Alternatively, the user may be asked to provide a payment option if this was not provided at step 260. If the user does not have Internet banking the merchant may display a screen asking for account details, credit card details, or the like.

However, it is usual at step 300 for some form of security check to be required to confirm that the user is genuinely the holder of the identified account, credit card or the like. This will typically take the form of a normal logon to a Internet banking scheme that may alternatively comprise the provision of a password pre-agreed with the financial institution, or the provision of private information which will uniquely identify the user, such as answering a number of security questions.

The financial institution server 4A receives any required information and then processes the payment at step 310.

At step 320 the financial institution server 4A will determine if a voucher is required. If so the financial institution server 4A generates the voucher at step 330 providing the voucher with a unique identifier. The unique identifier may be in the form of a unique alpha numeric sequence, coded image, barcode, or the like. The voucher is then transferred to the merchant at step 340.

Otherwise some other form of confirmation may be sent to the merchant indicating that the payment has been processed.

In any event, payment confirmation is displayed to the user at step 350. This will typically be performed by the financial institution server 4A either operating in accordance with normal way, for example by providing an online receipt or the like. It will be appreciated that this may be achieved by transferring a copy of any voucher generated above to the user end station 3.

At step 360 the financial institution server 4A terminates the secure connection to the end station 3 and this will typically result in the user being transferred back to the web page of the merchant which has been held in stasis while the transaction is performed.

Finally at step 370 the merchant obtains payment from the financial institution operating the financial institution server 4A, or from another institution, such as the user's bank, depending on the implementation. This will typically either be achieved in the normal way or by having the merchant cash in the voucher supplied by the financial institution. This may be performed by taking the voucher to the respective bank or through other alternative processes.

Thus, in the example above, the operation of the system within the Internet environment can be summarised as follows:
STEP 1: The card user goes to the payment page of the merchant's web site and nominates the transaction system as prescribed by the present invention as their preferred method of payment and identifies their bank or card issuer.
STEP 2: The merchant's web site generates a payment request to the bank or card issuer, this payment request may include:
   a) an indication of the user, and the transaction
   b) an indication of the user's end station
STEP 3: The bank or card issuer will then respond to the request by:
   a) initiating a secure connection with the user's end station
   b) obtaining security information from the user
   c) processing the request and authorising the transaction
   d) providing a payment indication (such as a voucher) to the merchant
STEP 4: The merchant then uses the payment indication to receive payment.

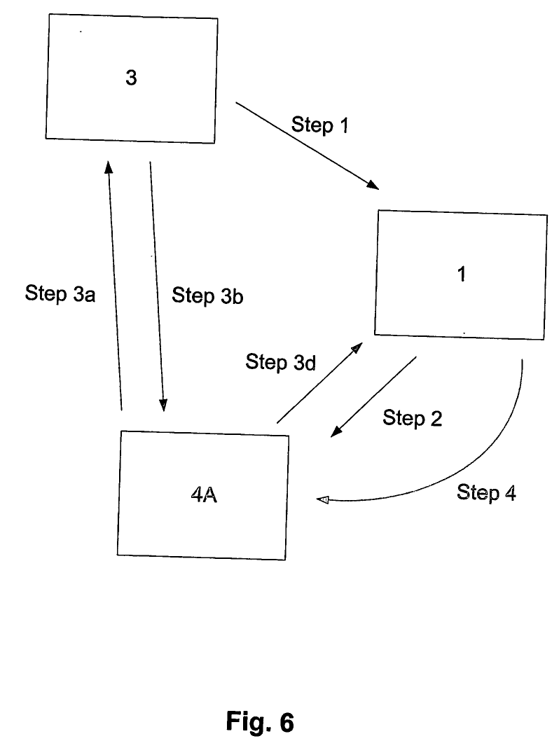

The interactions between the user end station 3, the merchant server 1 and the financial institution server 4A are shown in FIG. 6. In this case, step 4 is shown in dotted lines as this may be achieved by having the merchant present the payment indication to the financial institution in person if it is in the form of a voucher, as discussed in more detail below.

Payment

In the situation in which the voucher system is used as described above, the voucher could comprise an alphanumeric code, such as a series of numbers and letters which form the identification of the voucher. This series of number and letters will identify the merchant of the card user, or an authorisation number and payment amount as well as the card user's financial institution.

If the merchant does not have an account with the financial institution then they can claim payment by themselves by submitting the voucher to the financial institution of the card user, or they can pass details on to their payment processing administrator or broker for claiming. In this case the merchant's ID would need to be submitted with any claims for identification purposes.

The benefits of the voucher method include that issuance of the voucher indicates to the merchant that payment is guaranteed and that there can be no third party interference or fraud in relation to the voucher. The incidences of charge backs will be greatly reduced. When making the claim of payments the merchant will do so by secure link or in person. When submitting the voucher they will also have to disclose their secret merchant ID to the financial institution for verification. Monies will be paid into to the account of the merchant only.

The voucher will expire once used, and therefore be useless to any third parties.

It will therefore be appreciated that the merchant ID is not generally kept secret. However, the merchant ID is used by the financial institution to ensure that payment is genuinely provided to the merchant, and is not fraudulently obtained by another third party.

In order to achieve this, the merchant must identify themselves to the financial institution, with the merchant ID being used by the financial institution to access details provided by the bypass server 2. Thus, identification can be achieved in any one of a number of techniques, such as through the use of one-time passwords, digital signatures or certificates, a username and password, secret PIN or the like.

In this case, when the merchant registers with the bypass server, a secret user name and password or the like can be established and associated with the merchant ID. When confirming the identity of the merchant, the financial institution will check the username and password, either by comparing this to an indication of the username and password received from the bypass server 2, or by transferring the username and password to the bypass server 2 for verification. In this later case, the bypass server 2 can be adapted to verify the identity of the user and confirm this with the financial institution.

In order to implement the invention it is advantageous that each financial institution or credit issuer has their own clearing house to hold monies debited at the time of issuance of the vouchers, pending a claim by the merchant.

Financial Institution

It will be appreciated in the above that the term financial institution above is intended to represent any financial institution capable of holding or administering an account on behalf of the user and therefore will typically be the user's bank.

However, this need not be the case, and accordingly, in the above process the financial institution may represent a trusted third party that interacts with the user's bank to obtain authorisation for the payment.

Thus, in the process above the user may not contact the bank per se, but instead operates to contact a trusted third party who under the authority of the user, will obtain approval for the transaction on behalf of the user, from the user's bank. The bank or trusted third party will then issue a form of the bypass voucher or facilitate the payment process in accordance with the merchant's standing instructions.

In this case, it will be appreciated that the financial institution server 4A may be a single server operated by the user's bank, or the like, or may be a server implemented by a trusted third party and coupled to the bank as required.

The trusted third party could be the trusted third party implementing the bypass server 2, or a reputable payment administrator or even a bank or financial institution having no relationship with the user. For example, the trusted third party could be the bypass server 2, such that users register with the bypass server, allowing the bypass server to subsequently verify the identity of the user and perform transactions on their behalf.

This may occur for example where the user's bank or the like is not a member of the scheme. In this case, they are not registered with the bypass server 2 and would not therefore by able to determine the merchant via the merchant ID, and as a result there is no mechanism for the payment to occur. To avoid this, the user registers with a trusted third party, such as the bypass server 2.

In this instance, the trusted third party acts as the financial institution and acts to make payments on behalf of the user, such that the trusted third party effectively halds an account on behalf of the user. In this case, the user will be required to provide details of their respective account with the trusted third party to the third party in the manner described above. In this case, the trusted party may either operate some form of credit system, which allows the user to arrange payment of the trusted third party at a later date, such as by the presentation of an invoice by the third party. Alternatively, the third party may require cleared funds in advance which are held in an account on behalf of the user.

In any event, this allows the user to make transactions with multiple merchants using a single account held by the trusted third party acting as the user's financial institution for the purposes of online or other transactions.

Alternatively, instead of holding account, the trusted third party may be authorised to communicate with the user's bank or other financial institution on the user's behalf. In this instance, the third party will obtain security details from the user and therefore act as the financial institution in the above described method. The third party will then perform the check of the merchant ID as described above, before contacting the user's bank or other financial institution to arrange payment.

### ALTERNATIVE EXAMPLES

It will be appreciated that a number of variations on the above described technique may be implemented. Thus, for example, the merchant may supply details of the transaction to the user, with the user transferring these details to the financial institution. Thus, in this case, the payment request is not transferred from the merchant server to the financial institution server, but is instead transferred to the user end station 3 for subsequent forwarding to the financial institution server 4A.

In this case, the payment request can be in the form of an invoice or bill, which includes the merchant ID thereon. The user then transfers the merchant ID and details of the transaction to the financial institution server 4A, allowing the transaction to be performed.

It is also possible for the above system to be implemented either partially or totally via telephone, fax or in a face-to-face transaction environment. It will be appreciated that in these types of transactions there are again issues regarding the security of the purchaser's details, as outlined above with respect to online transactions.

Thus, in the case of telephonic transactions, the user end station 3, the merchant server 1 and financial institution server 4A may be replaced by individuals provided with telephones. It will be appreciated that the interaction between the individuals will follow a similar pattern to that outlined above. The same is true for face-to-face transactions, with communication between the user end station 3 and the merchant station 1 being replaced by communication between the user and the merchant.

Thus, in this case, the user and the merchant will initially negotiate the transaction, for example by having the user phone a telesales operative. Once the transaction has been agreed, details of the transaction need to be transferred to the user's financial institution.

This can occur in a number of ways. Thus, for example, the merchant can transfer details of the transaction to the user's financial institution. This may occur either through normal channels, via telephone, or via a secure connection between a merchant station 1 and a financial institution station 4A as described above. Alternatively, the merchant can provide the details to the user, for subsequent transferral to the financial institution. This can occur by having the merchant issue an invoice or the like, as mentioned above.

In either case, the merchant ID must be provided to the financial institution to allow the financial institution to pay the merchant. Thus, in the case of an invoice being issued, the invoice must include the merchant ID, to allow this to be transferred to the financial institution for processing.

Once the financial institution has determined the transaction to be performed, contact with the user is initiated. This may occur, for example by having the financial institution telephone the user on a mobile phone, or by having the user phone the financial institution on a predetermined phone number. In the case of telephone transactions between the merchant and user, this could be achieved by transferring the user to a secure telephone connection with the respective financial institution. In the case of face-to-face transactions, this could be performed via a secure connection between a financial institution server 4A and an end station 3. Thus, for example, if in a shop, the user could contact the financial institution via a PDA, or the like.

Alternatively, the user may use an ATM or the like to contact the financial institution. In this case, the ATM acts as the user end station 3, allowing the user to communicate with their financial institution to allow the transaction to be performed. In this instance, the financial institution can issue a voucher to the merchant directly, or alternatively via the ATM. Thus, for example, the user can obtain payment details from the merchant, use the ATM to supply these details to the financial institution, and then obtain the voucher from the ATM. The user can then present the voucher to the merchant, thereby effectively making payment.

In any event, if communication is via telephone, the user can provide the information required to perform the transaction either by speaking to an operative, or a voice recognition system implemented on a processing system, or by providing information using a touch tone keypad. This will usually take the form of account details, user name and passwords, or the like as described above.

Finally, confirmation of the transaction will again be transferred to the merchant, either via a telephone or server-to-server connection. Thus, as described above, the financial institution will typically issue a voucher to the merchant. This may be in the form of an alphanumeric code, or the like, which can therefore be communicated to the merchant via the telephone.

Alternatively the financial institution can arrange to credit a financial institution account of the merchant in accordance with predetermined standing instructions as described above.

It will be appreciated that unlike techniques according to the prior art, the present invention ensures that the financial information regarding the user, such as the user's credit card, financial institution account details are only ever submitted to their own financial institution. This helps improve security of the user's account details, credit card details, or the like as this will prevent them falling into the hands of third parties.

Furthermore, use of the voucher system to allow the merchant to obtain payment, allows the financial institutions to ensure that third parties are not able to redirect the payment to themselves. Furthermore, as the merchant has to register with the trusted third party, such as the bypass payment server 2 described above, this will provide the third party with the opportunity to validate the merchant as a genuine merchant, thereby ensuring that only genuine merchants are able to obtain the merchant ID, and therefore obtain payment.

A further feature available to the system is to allow additional information to be associated with the merchant ID. This may include for example any other information required to maintain the integrity and security of the scheme. This can be stored centrally at the bypass server 2, such that it may be accessed and viewed by the financial institutions, or users, for example through a suitable web-site, or disseminated to the financial institutions, and/or users for local storage and reference as required

For example, complaints made regarding the conduct of merchant may have been made to the trusted third party implementing the bypass server 2, which requires the merchant to be suspended from the scheme pending investigation. Alternatively, merchants may be assigned with an integrity rating made available to end users and banks depending on their level of interaction with the system.

In this case, the information could be checked by either the user or the financial institution before a transaction is made, to thereby further enhance the security of the system.

Definitions

The term “transactions” at least encompasses any form of communications between two or possibly more parties that relate to commerce, trade or the transfer of consideration or value. This is not intended to limit the interpretation of the term, which could therefore also include any communications had between two or more parties relating to any matter whatsoever

The term “financial institution” includes any entity or individual capable of making a payment, or arranging a payment on behalf of the user, but generally refers to an entity which administers or has a controlling interest in an account held by the user.

In this regard, the term “account” encompasses any system bearing any designation or entitlement of credit or otherwise, and is derived from any method or means, and includes but is not limited to bank accounts, credit accounts, credit card accounts, charge card accounts, loan accounts.

Security information may include any other information as required or in accordance with the security protocol as stipulated from time to time by the financial institution, or card issuer.

The term payment indication is intended to cover any form of indication that allows payment to be received by the merchant and in one example include an alpha-numeric code, which in another example may be incorporated into a voucher.

The term “payment” is not only limited to purchases of goods or services, but may also relate to the payment of bills, accounts or similar transactions where money is due and owing by the user to any third party. Thus, the system is not limited to transactions with merchants and may include transactions between any parties.

Furthermore, the term “merchant” is not intended to be restrictive, and is intended to cover any third party registered with the system to obtain an ID (commonly referred to as a merchant ID above) and to whom money is owed. This will therefore include regulatory or government bodies, or the like, as well as traders. This will therefore allow for example, users to go online to pay their car registration, tax or the like

Persons skilled in the art will appreciate that numerous variations and modifications will become apparent. All such variations and modifications which become apparent to persons skilled in the art, should be considered to fall within the spirit and scope that the invention broadly appearing before described.

1. A method of performing secure transactions between a user end station and a merchant station, the method including:
a) Transferring payment details from the end station to the merchant station;
b) Causing the merchant station to:
i) Generate a payment request including:
(1) An indication of the user's end station;
(2) An indication of the transaction; and,
ii) Transfer the payment request to a financial institution station in accordance with the payment details, the financial institution station holding an account of the user and being responsive to the payment request to obtain payment from the user via the user account.

2. A method according to claim 1, the account being at least one of:
a) A bank account; and,
b) A credit card account.

3. A method according to claim 1, the method including causing the financial institution station to respond to the payment request to:
a) Initiate a secure connection with the user's end station;
b) Obtain security information from the user end station;
c) Process the transaction; and,
d) Provide a payment indication to the merchant station.

4. A method according to claim 3, the security information including at least one of:
a) A username;
b) A password;
c) Credit card details;
d) Financial institution account details; and,
e) An indication of a preferred payment method.

5. A method according to claim 3, the secure connection being an SSL connection.

6. A method according to claim 3, the payment indication including a voucher, the voucher being used by the merchant to obtain payment.

7. A method according to claim 6, the method including:
a) Assigning a unique merchant ID to each merchant;
b) Causing the merchant station to include a unique merchant ID in the payment details; and,
c) Causing the financial institution station to:
i) Generate a unique identifier in accordance with the merchant ID, and,
ii) Provide the unique identifier on the voucher.

8. A method according to claim 1, the merchant station being adapted to transfer the payment request to the financial institution station via a secure SSL connection.

9. A method according to claim 1, the method including:
a) Causing the merchant station to generate web-pages including details of available products;
b) Allowing the user to select one or more of the products;
c) Causing the merchant station to generate a payment amount; and,
d) Causing the user to submit payment details in response to the payment amount.

10. Apparatus for performing secure transactions between a user end station and a merchant station, the apparatus including a merchant end station adapted to:
a) Receive payment details from the end station;
b) Generate a payment request including:
i) An indication of the user's end station;
ii) An indication of the transaction; and,
c) Transfer the payment request to a financial institution station in accordance with the payment details, the financial institution station holding an account of the user and being responsive to the payment request to obtain payment from the user via the user account.

11. Apparatus according to claim 10, the account being at least one of:
a) A bank account; and,
b) A credit card account.

12. Apparatus according to claim 10, the merchant station being assigned a respective merchant ID, the merchant station being adapted to include a unique merchant ID in the payment details.

13. Apparatus according to claim 10, the merchant station being adapted to transfer the payment request to the financial institution station via a secure SSL connection.

14. Apparatus according to claim 10, the merchant station being adapted to:
a) Generate web pages including details of available products;
b) Allow the user to select one or more of the products;
c) Generate a payment amount; and,
d) Receive payment details from the user end station in response to the payment amount.

15. Apparatus for authorising secure transactions between a user end station and a merchant station, the apparatus including a financial institution station adapted to:
a) Receive a payment request including:
i) An indication of the user's end station;
ii) An indication of the transaction; and,
b) Initiate a secure connection with the user's end station;
c) Obtain security information from the user end station;
d) Process the transaction; and,
e) Provide a payment indication to the merchant station.

16. Apparatus according to claim 15, the security information including at least one of:
a) A username;
b) A password;
c) Credit card details;
d) Financial institution account details; and,
e) An indication of a preferred payment method.

17. Apparatus according to claim 15, the secure connection being an SSL connection.

18. Apparatus according to claim 15, the payment indication including a voucher, the voucher being used by the merchant to obtain payment.

19. Apparatus according to claim 18, the payment request including a unique merchant ID, the financial institution station being adapted to:
a) Generate a unique identifier in accordance with the merchant ID, and,
b) Provide the unique identifier on the voucher.

20. A method of performing secure transactions between a first party and a second party, the method including:
a) Having the first party provide payment details to the second party;
b) Causing the second party to:
i) Generate a payment request including:
(1) An indication of the first party;
(2) An indication of the transaction; and,
iii) Transfer the payment request to a third party in accordance with the payment details, the third party administering an account on behalf of the first party and being responsive to the payment request to obtain payment from the first party from the account.

21. A method according to claim 20, the third party being a financial institution.

22. A method according to claim 21, the third party administering the account.

23. A method according to claim 20, the first party being a user.

24. A method according to claim 20, the second party being a merchant.

25. A method according to claim 20, the account being at least one of:
a) A bank account; and,
b) A credit card account.

26. A method according to claim 20, the method including causing the third party to respond to the payment request to:
a) Initiate a connection with the user;
b) Obtain security information from the user;
c) Process the transaction; and,
d) Provide a payment indication to the merchant.

27. A method according to claim 26, the connection being a secure connection.

28. A method according to claim 25, the security information including at least one of:
a) A username;
b) A password;
c) Credit card details;
d) Financial institution account details; and,
e) An indication of a preferred payment method.

29. A method according to claim 25, the payment indication including a voucher, the voucher being used by the merchant to obtain payment.

30. A method according to claim 29, the method including:
a) Assigning a unique ID to each second party;
b) Causing the second party to include the unique ID in the payment details; and,
c) Causing the financial institution to:
i) Generate a unique identifier in accordance with the unique ID, and,
ii) Provide the unique identifier on the voucher.

31. (canceled)

32. Apparatus for performing secure transactions between a first party and a second party, the apparatus including second party end station adapted to:
a) Receive payment details from the first party;
b) Generate a payment request including:
i) An indication of the first party;
ii) An indication of the transaction; and,
c) Transfer the payment request to a third party in accordance with the payment details, the third party administering an account on behalf of the first party and being responsive to the payment request to obtain payment from the first party from the account.

33. (canceled)

34. Apparatus for authorising secure transactions between first and second parties, the apparatus including a financial institution station adapted to:
a) Receive a payment request including.
i) An indication of the first party;
ii) An indication of the transaction; and,
b) Initiate a secure connection with the first party;
c) Obtain security information from the first party;
d) Process the transaction; and,
e) Provide a payment indication to the second party.

35. (canceled)

36. A system for performing secure transactions between a first party and a second party, the apparatus including a second party end station adapted to;
a) Receive payment details from the first party;
b) Generate a payment request including:
i) An indication of the first party;
ii) An indication of the transaction; and,
iii) Transfer the payment request to a third party in accordance with the payment details, the third party administering an account on behalf of the first party and being responsive to the payment request to obtain financial account details from the first party to thereby obtain payment from the first party from the account coupled via a communications network to a financial institution end station adapted to:
c) Receive a payment request including:
i) An indication of the first party;
ii) An indication of the transaction; and
d) Initiate a secure connection with the first party;
e) Obtain security information including financial account details from the first party;
f) Process the transaction; and
g) Provide a payment indication to the second party.

37. An electronic payment method to enable a user to securely purchase goods and services from a merchant, the method comprising the steps of:
a) accessing a merchant website remotely from a user computer via a computer network;
b) at a merchant website controlled by a merchant computer, enabling the user to select an account held with a financial institution from which payment is to be made;
c) generating a payment request at the merchant computer, said payment request including identification of the user computer, identification of the merchant, the transaction amount and the account;
d) electronically transmitting the payment request from the merchant computer to a financial institution computer, said financial institution computer controlled by the financial institution at which the account is held;
e) at the financial institution computer, initiating a secure communication connection with the user computer;
f) under the control of the user, transmitting security information from the user computer to the financial institution computer; and
g) if the security information is accepted by the financial institution, processing the payment request at the financial institution computer, and thereafter electronically providing a payment indication from the financial institution computer to the merchant computer.

38. The method of claim 37 wherein the account is a credit card account.

39. The method of claim 37 wherein the account is a savings account.

40. An electronic payment method to enable a user to securely pay a merchant from funds in an account, the user operating a user computer and maintaining an account with a financial institution, the method comprising the steps of:
a) accessing a merchant website remotely from the user computer via a computer network;
b) selecting the account held with a financial institution from which payment is to be made;
c) confirming a payment request, said payment request indicating the transaction amount and the account;
d) accepting a secure communication connection request from the financial institution; and
e) electronically transmitting security information from the user computer to the financial institution.

41. The method of claim 40 wherein the account is a credit card account.

42. The method of claim 40 wherein the account is a savings account.

43. A method of performing secure transactions between a user end station and a merchant station, the method including:
a) Transferring payment details from the end station to the merchant station, the payment details including an indication of a financial institution but no account details;
b) Causing the merchant station to:
i) Generate a payment request including:
(1) An indication of the user's end station;
(2) An indication of the transaction; and,
ii) Transfer the payment request to a financial institution station in accordance with the payment details, the financial institution station holding an account of the user and being responsive to the payment request to obtain payment from the user via the user account.

44. A method of performing secure transactions between a user end station and a merchant station, the method including:
a) Transferring payment details from the end station to the merchant station;
b) Causing the merchant station to:
i) Generate a payment request including:
(1) An indication of the user's end station;
(2) An indication of the transaction; and,
ii) Transfer the payment request to a financial institution station in accordance with the payment details, the financial institution station holding an account of the user and being responsive to the payment request to obtain payment from the user via the user account, and wherein account details are not transferred to the merchant station.

45. A method of performing secure transactions between a user end station and a merchant station, the method including:
a) Transferring payment details from the end station to the merchant station;
b) Causing the merchant station to:
i) Generate a payment request including:
(1) An indication of the user's end station;
(2) An indication of the transaction; and,
ii) Transfer the payment request to a financial institution station in accordance with the payment details, the financial institution station holding an account of the user and being responsive to the payment request to obtain payment from the user via the user account.
